(19) United States
(12) Patent Application Publication
(10) Pub. No.: US 2022/0389200 A1
(43) Pub. Date: Dec. 8, 2022

(54) POROUS CARBON FIBERS REINFORCED RUBBER COMPOSITES

(71) Applicant: Ford Global Technologies, LLC, Dearborn, MI (US)

(72) Inventors: Cindy Sofia Barrera-Martinez, Dearborn, MI (US); Janice Lisa Tardiff, Plymouth, MI (US); Wenqi Zhao, Blacksburg, VA (US); Guoliang Liu, Blacksburg, VA (US)

(73) Assignee: Ford Global Technologies, LLC, Dearborn, MI (US)

(21) Appl. No.: 17/340,648

(22) Filed: Jun. 7, 2021

(51) Int. Cl. C08L 9/06; C08K 7/06; C08K 9/02; D01F 9/22; C08L 7/00

(52) U.S. Cl. CPC C08L 9/06; C08K 7/06; C08K 9/02; D01F 9/22; C08L 7/00; D10B 2401/10

(57) ABSTRACT

A rubber composition includes a rubber matrix and carbon fibers dispersed within the rubber matrix. The carbon fibers define a plurality of pores distributed throughout the carbon fibers and a surface chemistry including doped nitrogen and doped oxygen. The rubber composition also may include a plurality of additives selected from a crosslinking agent, at least one activator, and at least one accelerator, among others.

### FIELD

The present disclosure relates generally to rubber compositions, and more specifically to rubber compositions having structural reinforcements.

### BACKGROUND

The statements in this section merely provide background information related to the present disclosure and may not constitute prior art.

Rubber materials are used in a variety of motor vehicle applications including tires, seals, mats, and mounts among others. In many of these applications, rubber compositions often include additives known as fillers to achieve desired performance and processability depending on specific performance requirements of the application. Carbon black, silica, and other mineral fillers such as talc and clay are conventionally used to modify the properties of the rubber to enhance mechanical properties. These fillers provide limited reinforcement to the rubber and thus other reinforcements have been investigated. For example, nano-sized carbon particles, such as graphene and carbon nanotubes, have been implemented, however, dispersion of these fillers in rubber is challenging due to a strong interaction between the particles. Moreover, these nano-fillers are prohibitively expensive for commercial applications of rubber, especially in the automotive industry.

These issues related to the reinforcement of rubber compositions, among other issues related to the formulation of such rubber compositions, are addressed by the present disclosure.

### SUMMARY

This section provides a general summary of the disclosure and is not a comprehensive disclosure of its full scope or all of its features.

In one form of the present disclosure, a rubber composition comprises a rubber matrix and carbon fibers dispersed within the rubber matrix, the carbon fibers defining a plurality of pores distributed throughout the carbon fibers. In variations of this composition, which may be implemented individually or in any combination, a pore size of the plurality of pores is selected from the group consisting of micropores, mesopores, and macropores, the plurality of pores are uniformly distributed throughout the carbon fibers, a surface chemistry of the carbon fibers comprises doped nitrogen and doped oxygen, the carbon fibers are manufactured by a process that begins with a PAN-b-PMMA (poly(acrylonitrile-block-methyl methacrylate)) precursor and/or a PAN (polyacrylonitrile)/PMMA (poly(methyl methacrylate)) blend precursor, a plurality of pores in PAN (polyacrylonitrile) fibers are formed when a PMMA (poly(methyl methacrylate)) phase is removed by pyrolysis, a diameter of the carbon fibers is sized by electrospinning, melting spinning, and/or dry/wey spinning, a porosity of the carbon fibers is between 20% and 80%, the rubber matrix comprises natural rubber and/or synthetic rubber, and the carbon fibers are uniformly distributed within the rubber matrix.

In addition, the rubber composition may further comprise a plurality of additives selected from the group consisting of a crosslinking agent, at least one activator, and at least one accelerator. Further, various applications for the rubber compositions according to the present disclosure are contemplated, including by way of example, a tire and parts for a motor vehicle.

In another form of the present disclosure, a rubber composition comprises a rubber matrix, carbon fibers dispersed within the rubber matrix, the carbon fibers defining a plurality of pores distributed throughout the carbon fibers and a surface chemistry comprising doped nitrogen and doped oxygen, and a plurality of additives selected from the group consisting of a crosslinking agent, at least one activator, and at least one accelerator. In a variation of this form of the present disclosure, the plurality of pores are uniformly distributed throughout the carbon fibers.

In yet another form of the present disclosure, a rubber composition comprises a rubber matrix, carbon fibers dispersed within the rubber matrix, the carbon fibers defining a plurality of pores uniformly distributed throughout the carbon fibers and a surface chemistry comprising doped nitrogen and doped oxygen, wherein the porous carbon fibers are produced by a process comprising synthesizing a block copolymer and/or a polymer blend consisting of PAN (polyacrylonitrile) and PMMA (poly(methyl methacrylate)), electrospinning the block copolymer and/or the polymer blend consisting of PAN (polyacrylonitrile) and PMMA (poly(methyl methacrylate)) to create fibrous strands, oxidizing the fibrous strands to separate the PAN (polyacrylonitrile) and PMMA (poly(methyl methacrylate)), and undergoing a pyrolysis step to carbonize the PAN (polyacrylonitrile) and remove the PMMA (poly(methyl methacrylate)), and a plurality of additives selected from the group consisting of a crosslinking agent, at least one activator, and at least one accelerator.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a rubber composition having porous carbon fibers dispersed within a rubber matrix according to the teachings of the present disclosure;

FIGS. 2A to 2D illustrate scanning electron microscope (SEM) views of the porous carbon fibers of a rubber composition according to the teachings of the present disclosure;

FIG. 3 illustrates a process for producing porous carbon fibers for rubber compositions according to the teachings of the present disclosure;

FIGS. 4A and 4B are cross-sectional scanning electron microscope (SEM) images at different magnifications of rubber compositions having conventional carbon black filler according to the prior art;

FIG. 4C is a perspective view of a rubber composition showing conventional carbon black filler in rubber matrix according to the prior art;

FIGS. 4D and 4E are cross-sectional scanning electron microscope (SEM) images at different magnifications of rubber compositions having porous carbon fibers according to the present disclosure;

FIG. 4F is a perspective view of a rubber composition showing the porous carbon fibers in a rubber matrix according to the present disclosure;

FIG. 5A is a graph comparing strain versus stress of pure (“neat”) rubber samples, conventional rubber compositions with carbon black filler, and rubber compositions according to the present disclosure;

FIG. 5B is a graph comparing strain versus stress of rubber compositions having varying amounts of porous carbon fibers according to the present disclosure; and

FIG. 6A is a graph comparing Young's modulus of conventional rubber compositions with carbon black and rubber compositions with porous carbon fibers of the present disclosure, at varying amounts of parts per hundred rubber (PHR); and

FIG. 6B is a graph comparing stress at 300% elongation of conventional rubber compositions with carbon black and rubber compositions with porous carbon fibers of the present disclosure, at varying amounts of PHR.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The rubber compositions according to the present disclosure are intended for use in parts for motor vehicle applications such as tires, seals, mats, and mounts, among others. When used in tires, the rubber composition of the present disclosure may be used in one or more components of the tire including, but not limited to, treads, sidewalls, innerliners, apexes, and ply rubbers, among others. It should be understood, however, that these motor vehicle applications are intended for illustrative purposes only and are not intended to limit the scope of the present disclosure. Accordingly, the teachings of the present disclosure may be applied to a variety of rubber applications.

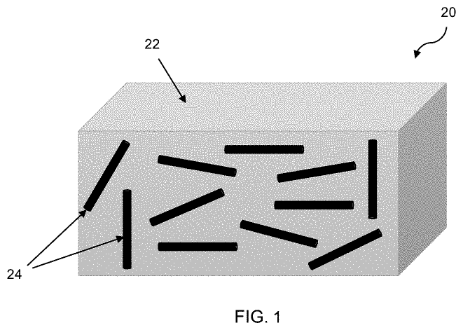

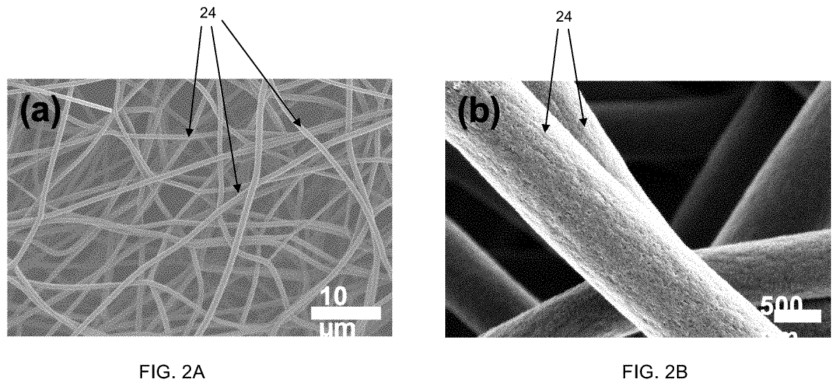

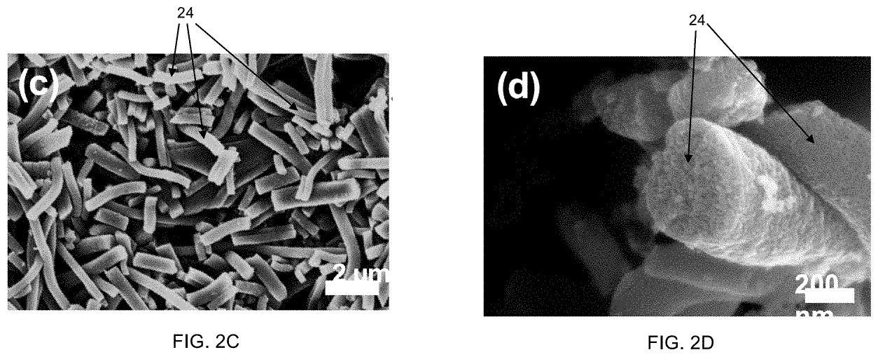

Referring to FIGS. 1 and 2A to 2D, in one form of the present disclosure, a rubber composition 20 comprises a rubber matrix 22 and carbon fibers 24 dispersed within the rubber matrix 22. Advantageously, the carbon fibers 24 define a plurality of pores distributed throughout the carbon fibers 24 (also referred to as “porous carbon fibers”). These pores generally provide a larger surface area and a “tunable” surface chemistry (as described in greater detail below), thereby enabling use as a structural filler in a variety of different rubber compositions and applications. A three-dimensional porous network provided by the porous carbon fibers 24 provides large interfacial contact area (“interlocking”) with the rubber matrix 22, while reducing issues related to agglomeration of structural fillers. Further, the rubber matrix 22 material and various additives are contemplated by the teachings herein, examples of which are set forth in greater detail below and which are not intended to be exhaustive of the scope of the present disclosure.

The pore size varies depending on the application and the pores sizes may be micropores, mesopores, and/or macropores. As used herein, the term “micropores” means pores with a diameter less than 2 nm, “mesopores” means pores with a diameter between 2 nm and 50 nm, and “macropores” means pores with a diameter greater than 50 nm. No matter the size of the pores, in one variation of the present disclosure, the pores are uniformly distributed throughout the carbon fibers 24.

Relative to the “tunable” surface chemistry, in one form a surface chemistry of the carbon fibers 24 comprises doped nitrogen and doped oxygen. Due to the inherent nitrogen in PAN (polyacrylonitrile) and the oxygen in PMMA (poly(methyl methacrylate)), as well as the additional oxygen introduced during oxidation, the carbon fibers 24 possess high levels of nitrogen and oxygen doping. Further nitrogen and oxygen heteroatoms further enhance the chemical interactions of the carbon fibers 24 with the rubber matrix, thereby improving mechanical properties of the rubber composition 20. This doping may also be accomplished by post-synthesis modification methods such as chemical vapor deposition, physical vapor deposition, chemical etching, and chemical functionalization, among others. Further, the concentrations of nitrogen and oxygen can be modified, or “tuned,” by thermal treatment.

More specifically, doping can be measured by surface atomic analysis methods such as x-ray photoelectron spectroscopy (XPS). The amount of oxygen and nitrogen in the carbon fibers 24 controls compatibility with different polar or non-polar polymers, and thus the type and amount of doping will vary depending on the specific polymer being used. For mixing with polar matrices, a higher amount of nitrogen and oxygen is desired. However, too much nitrogen and oxygen can cause the carbon matrix to collapse. Therefore, the amount of nitrogen and/or oxygen is determined by the specific application. By way of example, for amine functionalization, more nitrogen is desired, but for hydroxyl and carboxyl functionalization, more oxygen is desired. If both types of functionalization are implemented, then both nitrogen and oxygen should be maximized.

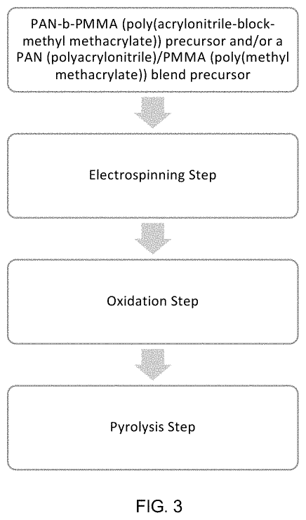

Referring now to FIG. 3, the carbon fibers 24 in one form are manufactured by a process that begins with a PAN-b-PMMA (poly(acrylonitrile-block-methyl methacrylate)) precursor and/or a PAN (polyacrylonitrile)/PMMA (poly(methyl methacrylate)) blend precursor. After synthesizing the precursor, it undergoes an electrospinning process, which generally uses electric force to create fibrous strands. It should be noted that in this electrospinning process, the diameter of the fibers can be controlled such that a specific size of carbon fibers 24 results. Furthermore, it should be understood that the diameter of the carbon fibers may also be sized by melting spinning and/or wet/dry spinning. Next, the polymer undergoes an oxidation heating process, in which the PAN and PMMA are separated, resulting in strands of PAN and in general, uniformly scattered areas of PMMA. Finally, the polymer is heated to an even higher temperature, in a pyrolysis process, which solidifies the PAN into carbon fibers and removes the PMMA, thereby resulting in the pores being formed throughout the carbon fibers 24. Accordingly, the plurality of pores in the PAN (polyacrylonitrile) fibers are formed when the PMMA (poly(methyl methacrylate)) phase is removed by pyrolysis. One such method is disclosed in published international application WO 2019/204762, titled “BLOCK COPOLYMER POROUS CARBON FIBERS AND USES THEREOF,” the contents of which are incorporated herein by reference in their entirety.

As set forth above, the rubber composition 20 further comprises a plurality of additives, some of which are a function of specific application requirements. In general, the additives include at least a crosslinking agent, at least one activator, and at least one accelerator. The crosslinking agent generally aids in bonding to provide a strong molecular structure and to provide elasticity in the rubber composition (this crosslinking is also referred to as “vulcanization” in synthetic rubber compositions). Generally, the activator and accelerator are used to start and speed up the rubber manufacturing process, or vulcanization process, respectively.

By way of example, the crosslinking agent may be a sulfur crosslinking system, a peroxide crosslinking system, a urethane crosslinking system, a metallic oxide crosslinking system, an acetoxysilane crosslinking system, and/or a radiation-based crosslinking system, but is not limited thereto. The at least one accelerator may be N-tert-butyl-benzothiazole sulfonamide (TBBS), zinc diethyl dithiocarbamate (ZDEC), diphenyl guanidine (DPG), dipentamethylenethiuram hexasulfide (Sulfads®), or a combination thereof. However, the present disclosure is not limited thereto. The plurality of additives may also include at least one filler, at least one processing aid, at least one antiozonant, and/or at least one antioxidant, among others. Fillers are commonly used to reinforce rubber compositions. Processing aids function as lubricants and facilitate and improve blending of fillers and additives in rubber compositions. Antiozonants and antioxidants protect rubber articles from ozone and oxygen, respectively.

Exemplary ranges of the additives in the rubber composition of the present disclosure are provided below in Tables 1-4, for applications of an engine mount (Table 1), a tire tread (Table 2), an automotive mat (Table 3), and rubber plugs, boots, and exhaust hangers (Table 4).

TABLE 1
Exemplary Composition of an Engine Mount Rubber Composite

| Component | PHR |
|---|---|
| Natural Rubber CV60 | 100 |
| Carbon Black N330 | 50.00 |
| Naphthenic Oil—(processing aid) | 10.00 |
| Zinc Oxide—(activator) | 10.00 |
| Stearic Acid—(used for lubrication and adhesion) | 2.00 |
| Antiozonant PD-2 | 2.00 |
| Antioxidant DQ | 2.00 |
| Sulfur—(crosslinking agent) | 0.25 |
| N-tert-butyl-benzothiazole Sulfonamide (TBBS)—(accelerator) | 2.10 |
| Tetramethylthiuram Disulfide (TMTD)—(accelerator) | 1.00 |

TABLE 2
Exemplary Composition of a Tire Tread Rubber Composite

| Component | PHR |
|---|---|
| Styrene-Butadiene Rubber (SBR) | 100 |
| Carbon Black | 10.00 |
| Precipitated Silica | 60.00 |
| Coupling Agent | 4.80 |
| Naphthenic Oil—(processing aid) | 33.12 |
| Microcrystalline Wax—(antiozonant) | 2.00 |
| Antiozonant | 2.00 |
| Antioxidant | 0.50 |
| Zinc Oxide—(activator) | 1.90 |
| Stearic Acid—(used for lubrication and adhesion) | 1.50 |
| Processing Aid | 2.00 |
| Sulfur—(crosslinking agent) | 1.50 |
| Accelerator 1 | 1.30 |
| Accelerator 2 | 1.50 |

TABLE 3
Exemplary Composition of an Automotive Mat Rubber Composite

| Component | PHR |
|---|---|
| Styrene-Butadiene Rubber (SBR-OE (naphthenic)) | 150 |
| Stearic Acid—(used for lubrication and adhesion) | 4.00 |
| Zinc Oxide—(activator) | 4.00 |
| Antiozonant 1 | 1.50 |
| Antiozonant 2 | 3.00 |
| Glycol Activator (ethylene or propylene glycol) | 2.00 |
| Clay—(filler) | 200 |
| Calcium Carbonate—(used for strength and abrasion resistance) | 100 |
| Sulfur—(crosslinking agent) | 4.00 |
| Accelerator CBS | 2.00 |
| Accelerator DPG | 0.40 |
| Silica—(filler) | 25.00 |

TABLE 4
Exemplary Composition of a Rubber Plug, Boot, or Exhaust Hanger
Rubber Composite

| Component | PHR |
|---|---|
| Ethylene Propylene Diene Monomer Rubber (EPDM) | 100 |
| Paraffinic Oil—(processing aid) | 70.00 |
| N550 Carbon Black | 105 |
| Zinc Oxide—(activator) | 5.00 |
| Stearic Acid—(used for lubrication and adhesion) | 1.50 |
| Accelerator 1 | 1.00 |
| Accelerator 2 | 1.80 |
| Accelerator 3 | 3.00 |
| Sulfur—(crosslinking agent) | 0.80 |

It should be understood, however, that the present disclosure is not limited to these specific compositions and their PHR amounts. The specific additives and their amounts will vary depending on the application.

Relative to the amount of porosity in the carbon fibers 24, the porosity may range between 20% and 80%. Again, this is a function of the specific application and this exemplary range should not be construed as limiting the scope of the present disclosure.

The rubber matrix 22 may be natural rubber, synthetic rubber, a combination of natural rubber and synthetic rubber, or a combination of different synthetic rubbers. For example, the synthetic rubber may be a synthetic isoprene rubber (IR), butadiene rubber (BR), styrene-butadiene rubber (SBR), ethylene propylene diene monomer (EPDM), nitrile butadiene rubber (NBR), and/or silicone rubber, among others. However, the present disclosure is not limited thereto.

In one form of the present disclosure, the carbon fibers 24 are uniformly distributed within the rubber matrix 22.

### Experimental Test Data

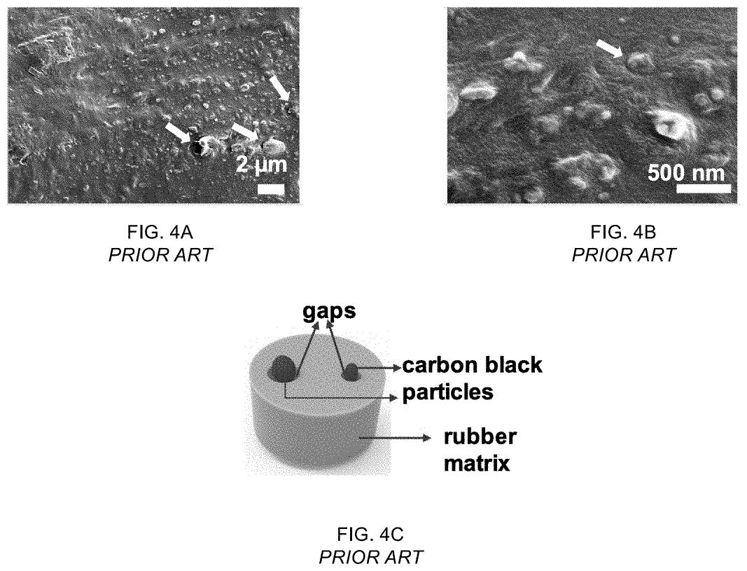

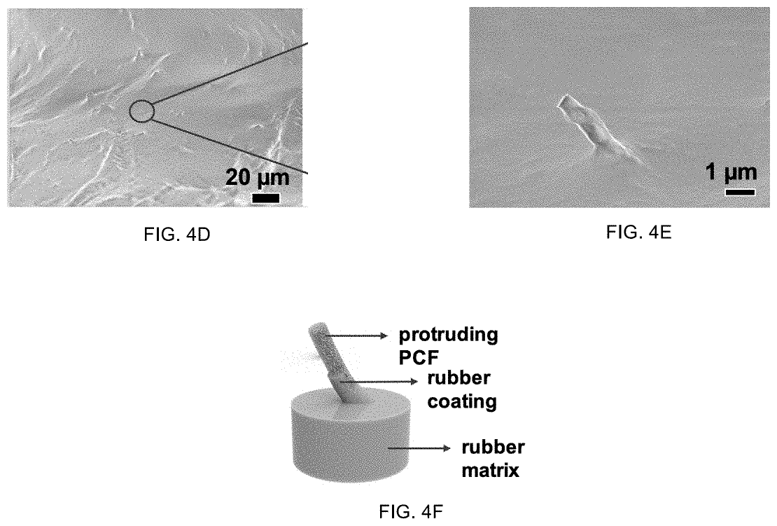

Referring to FIGS. 4A and 4B, scanning electron microscope (SEM) images of an example rubber composite containing conventional carbon black filler are shown. As shown in the model illustrated in FIG. 4C, gaps are present between the carbon black particles and the rubber matrix. This poor interfacial contact leads to reduced mechanical properties of the rubber composite using conventional carbon black filler.

By comparison, and with reference to FIGS. 4D and 4E, scanning electron microscope (SEM) images of an example rubber composite containing the porous carbon fibers according to the present disclosure are shown. In these rubber compositions, the rubber matrix generally coats and is interfacially bonded to the porous carbon fibers (see FIG. 4F). As a result, the porous carbon fibers, especially when they are doped with nitrogen and oxygen, provide significantly improved mechanical properties of the rubber composition as illustrated and described in the following. It should be understood that the specific values for mechanical properties are merely exemplary and should not be used to limit the scope of the present disclosure.

Mechanical testing was conducted to compare the properties of the conventional rubber composites having carbon black filler against the rubber composition of the present disclosure.

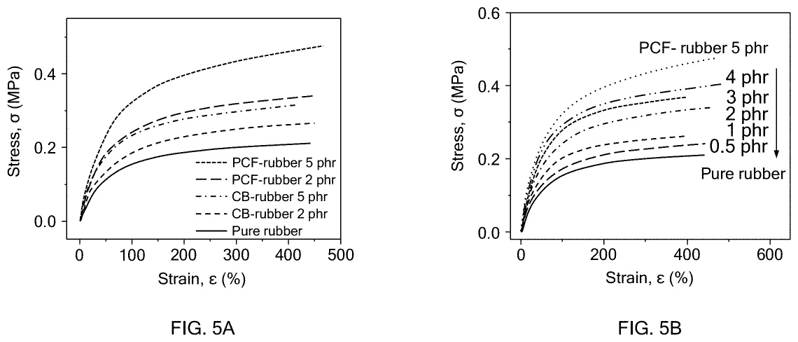

Referring to FIGS. 5A and 5B, stress versus strain are shown for various rubber compositions, as well as pure (“neat”) rubber. Both conventional rubber containing carbon black filler (“CB”), and rubber compositions according to the present disclosure with porous carbon fibers (“PCF”) are shown at vary amounts of PHR. As shown, the rubber compositions having porous carbon fibers and surface doping performed significantly better than conventional rubber compositions.

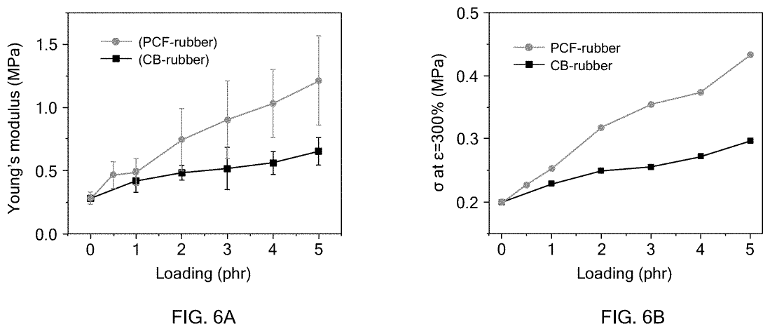

Referring to FIGS. 6A and 6B, the amount of filler versus Young's Modulus (FIG. 6A) and stress at 300% elongation (FIG. 6B) is shown for both conventional rubber compositions containing carbon black filler (“CB”) and rubber compositions according to the present disclosure with porous carbon fibers (“PCF”). Once again, the rubber compositions according to the present disclosure provide significantly improved mechanical properties compared to the conventional rubber compositions.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A rubber composition comprising:
a rubber matrix; and
carbon fibers dispersed within the rubber matrix, the carbon fibers defining a plurality of pores distributed throughout the carbon fibers.

2. The rubber composition according to claim 1, wherein a pore size of the plurality of pores is selected from the group consisting of micropores, mesopores, and macropores.

3. The rubber composition according to claim 1, wherein the plurality of pores are uniformly distributed throughout the carbon fibers.

4. The rubber composition according to claim 1, wherein a surface chemistry of the carbon fibers comprises doped nitrogen and doped oxygen.

5. The rubber composition according to claim 1, wherein the carbon fibers are manufactured by a process that begins with a PAN-b-PMMA (poly(acrylonitrile-block-methyl methacrylate)) precursor and/or a PAN (polyacrylonitrile)/PMMA (poly(methyl methacrylate)) blend precursor.

6. The rubber composition according to claim 5, wherein a plurality of pores in PAN (polyacrylonitrile) fibers are formed when a PMMA (poly(methyl methacrylate)) phase is removed by pyrolysis.

7. The rubber composition according to claim 1, wherein a diameter of the carbon fibers is sized by electrospinning, melting spinning, and/or dry/wet spinning.

8. The rubber composition according to claim 1 further comprising a plurality of additives selected from the group consisting of a crosslinking agent, at least one activator, and at least one accelerator.

9. The rubber composition according to claim 1, wherein a porosity of the carbon fibers is between 20% and 80%.

10. The rubber composition according to claim 1, wherein the rubber matrix comprises natural rubber and/or synthetic rubber.

11. The rubber composition according to claim 1, wherein the carbon fibers are uniformly distributed within the rubber matrix.

12. A tire comprising the rubber composition according to claim 1.

13. A motor vehicle comprising at least one part made from the rubber composition according to claim 1.

14. A rubber composition comprising:
a rubber matrix;
carbon fibers dispersed within the rubber matrix, the carbon fibers defining:
a plurality of pores distributed throughout the carbon fibers; and
a surface chemistry comprising doped nitrogen and doped oxygen; and
a plurality of additives selected from the group consisting of a crosslinking agent, at least one activator, and at least one accelerator.

15. The rubber composition according to claim 14, wherein the plurality of pores are uniformly distributed throughout the carbon fibers.

16. A tire comprising the rubber composition according to claim 14.

17. A motor vehicle comprising at least one part made from the rubber composition according to claim 14.

18. A rubber composition comprising:
a rubber matrix;
carbon fibers dispersed within the rubber matrix, the carbon fibers defining:
a plurality of pores uniformly distributed throughout the carbon fibers; and
a surface chemistry comprising doped nitrogen and doped oxygen,
wherein porous carbon fibers are produced by a process comprising synthesizing a block copolymer and/or a polymer blend consisting of PAN (polyacrylonitrile) and PMMA (poly(methyl methacrylate)), electrospinning the block copolymer and/or the polymer blend consisting of PAN (polyacrylonitrile) and PMMA (poly(methyl methacrylate)) to create fibrous strands, oxidizing the fibrous strands to separate the PAN (polyacrylonitrile) and PMMA (poly(methyl methacrylate)), and undergoing a pyrolysis step to carbonize the PAN (polyacrylonitrile) and remove the PMMA (poly(methyl methacrylate)); and
a plurality of additives selected from the group consisting of a crosslinking agent, at least one activator, and at least one accelerator.

19. A tire comprising the rubber composition according to claim 18.

20. A motor vehicle comprising at least one part made from the rubber composition according to claim 18.
